(19) United States
(12) Patent Application Publication
(10) Pub. No.: US 2014/0362212 A1
(43) Pub. Date: Dec. 11, 2014

(54) ILLUMINATING SURVEILLANCE CAMERA

(71) Applicant: LKU Technology Ltd., Taipei (TW)

(72) Inventor: Min-Chieh Hsu, Taipei (TW)

(21) Appl. No.: 13/910,232

(22) Filed: Jun. 5, 2013

(51) Int. Cl. H04N 7/18; H04N 5/225

(52) U.S. Cl. CPC H04N 7/18; H04N 5/2256
USPC 348/143

(57) ABSTRACT

An illuminating surveillance camera includes a sensing module to sense a human body temperature and environment luminance and generate a characteristic signal, a surveillance camera module having a controller to generate a controlling signal in response to the characteristic signal and an illuminating module installed on a side of the surveillance camera to project light in response to the controlling signal.

### BACKGROUND OF THE INVENTION

1. Field of the Invention

This invention is related to a surveillance camera, and more particular, to a surveillance camera capable of emitting light to provide a bright background after sensing temperature of a moving object and luminance of the environment.

2. Description of Related Art

A surveillance camera has been used in various fields to pose a threat to ill-minded personnel so as to achieve the purpose of reducing crime rate. In addition to intimidate criminals, the surveillance camera also helps the authority to fight the crime by recording what is really happening at the crime scene. However, given the vast open space and lack of funding, there is little resource left for a lot of areas to provide good lighting. As a consequence of the situation being considered, either there is no surveillance camera to record the scene or the image recorded by the surveillance camera is blurred and often cannot be identified.

Again, when the surveillance camera is installed in place, it seems that the surveillance camera serves one function and one function only, to record the image within the possible angles. With the default function for the surveillance camera, when there is a need for projecting images to promote festival atmosphere, it seems little left for the existing surveillance camera. For example, during the Christmas season, all the decorations are placed after the installation of the surveillance camera and the surveillance camera can do nothing to add anything to the festival atmosphere.

In order to obviate the aforementioned shortcomings, it is an objective of the present invention to provide an improved surveillance camera to illuminate when necessary.

### SUMMARY OF THE INVENTION

The primary objective of the present invention is to provide an illuminating surveillance camera to illuminate light when the luminance so sensed is inadequate when compared with a predetermined value stored in a controller inside the surveillance camera.

In order to accomplish the aforementioned objective, the preferred embodiment of the present invention provides an improved surveillance camera to sense a human body temperature and environment luminance and send a corresponding signal to a controller. After comparing the sent signal characterizing the sensed human body temperature and the environment luminance with a predetermined values inside the controller, the controller sends out a controlling signal to activate an illuminating module installed on a side of the camera when the environment luminance fails to reach the predetermined value inside the controller.

### BRIEF DESCRIPTION OF THE DRAWINGS

The preferred embodiment(s) of the invention, as well as its many advantages, may be further understood by the following detailed description and accompanying drawings.

FIG. 1 is a perspective view showing the elements of the preferred embodiment of the present invention;

FIG. 2 is a perspective view showing the preferred embodiment of the present invention;

FIG. 3 is still another perspective view showing the preferred embodiment of the present invention;

FIG. 4 is another perspective view of the preferred embodiment of the present invention; and

FIG. 5 is a block diagram showing the assembly of the preferred embodiment of the present invention.

### DETAILED DESCRIPTION OF THE INVENTION

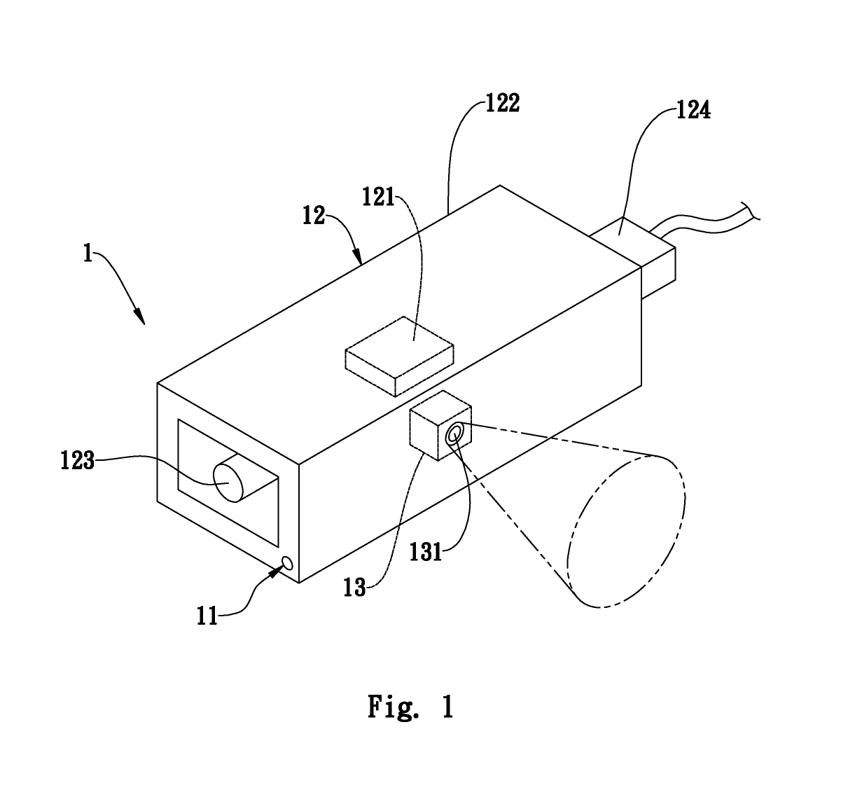

With reference to FIG. 1, it is noted that the illuminating surveillance camera 1 constructed in accordance with the present invention is composed of a surveillance camera 12, a sensing module 11 and an illuminating module 13.

The surveillance camera 12 has a housing 122, a controller 121 installed inside the housing 122 and a camera 123 embedded inside the housing 122 and partially extending out of the housing 122 for capturing an image.

The sensing module 11 is securely provided on a side of the housing 122 to sense a human body temperature and environment luminance.

The illuminating module 13 is installed inside the housing 122 and has an illuminating unit 131 inside the illuminating module 13 to project light when necessary. The illuminating unit 131 may be a light emitting diode (LED) or a light bulb. In addition to that a power supply 124 is electrically connected to the controller 121, the camera 123 and the illuminating module 13 to provide electricity thereto.

When the illuminating surveillance camera of the preferred embodiment of the present invention is used, the sensing module 11 first senses a human body temperature and environment luminance and generates a corresponding characteristic signal. The characteristic signal is sent to the controller 121 for comparison with default values predetermined stored inside the controller 121. When either value of the human body temperature or the environment luminance is below or less than the predetermined values inside the controller 121, the controller 121 will not generate a controlling signal to activate the illuminating module 13 to project light. For example, during the daytime, the sensed human body temperature or the environment luminance is either smaller or less than the predetermined value of the controller 121 and there will be no controlling signal sent to the illuminating module 13. However, when it is the nighttime, both the human body temperature and the environment luminance are smaller than the predetermined values of the controller 121 such that the controller 121 generates the controlling signal and the controlling signal is sent to the illuminating module 13 and activate the same.

In the preferred embodiment of the present invention, the illuminating module 13 may be a decorative LED lighting module, a laser lighting module or a fluorescent lighting module.

As described earlier, the illuminating unit 131 of the illuminating module 13 may be made fixed to the housing 122 of the surveillance camera 12 or rotatable relative to the housing 122 of the surveillance camera 12 to provide varieties so as to meet different requirements. Further, the lighting from the illuminating unit 131 may cast a picture, a character, a combination thereof or any one of the above. Also, the color of the cast light may be one of the following colors: red, orange, yellow, green, blue, indigo and violet.

When the cast light presents a picture, the picture may be an animal, a plant, a bug, a human figure, a cartoon figure, traffic signs or a transportation means. When the cast light presents a character, the character may be a name, a number, a model, a warning or a congratulation language. Or the cast light presents a combination of any two of the above.

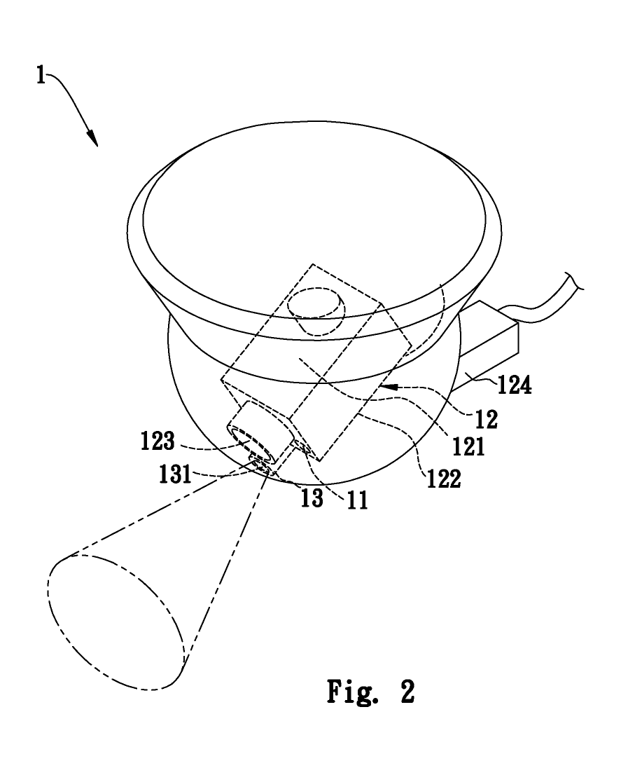

With reference to FIG. 2, it is noted that the illuminating surveillance camera 1 of the preferred embodiment of the present invention has the illuminating module 13 along with its illuminating unit 131 installed in a direction aligned with the sensing module 11 such that the illuminating module 13 is able to provide sufficient lighting to illuminate the subject to be captured by the surveillance camera 123.

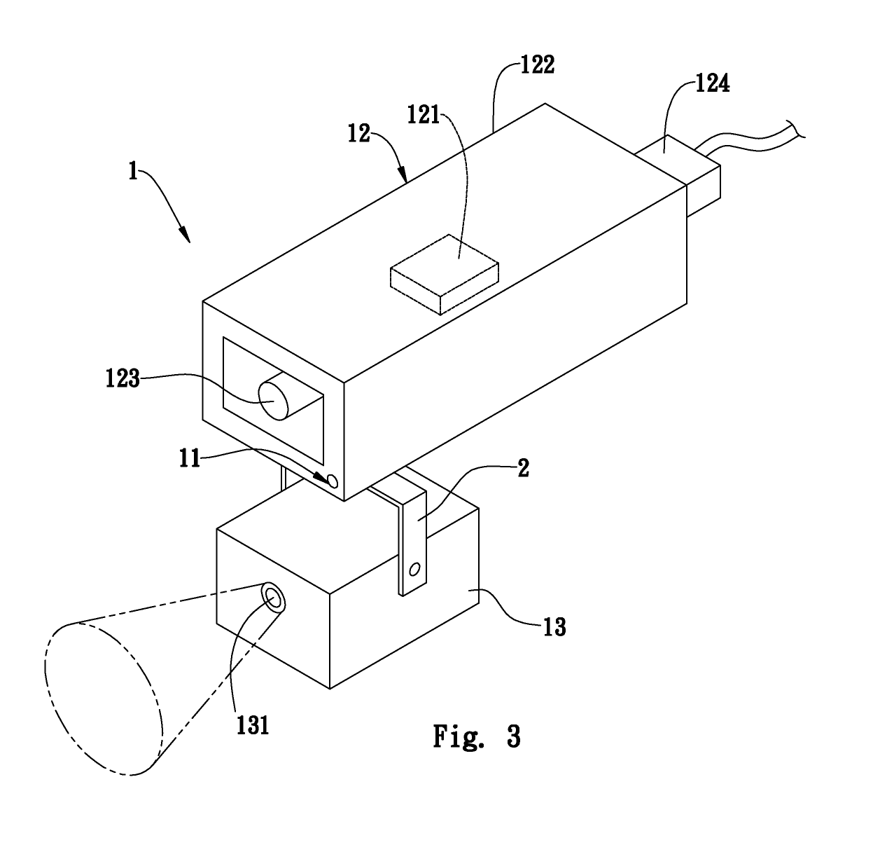

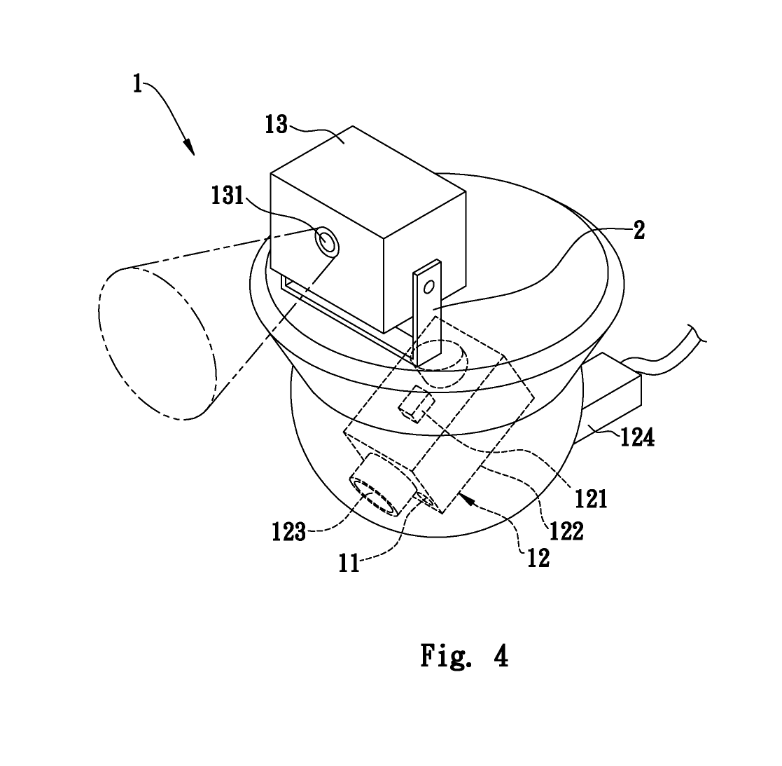

With reference to FIGS. 3 and 4, it is noted that a connector 2 is provided between the surveillance camera 12 and the illuminating module 13. The connector 2 is securely connected to a bottom face of the housing 122 and pivotally connected to the illuminating module 13. In this preferred embodiment, the connector 2 has two extensions (not numbered) extending in two directions to respectively and pivotally connect to side faces of the illuminating module 13 to allow the illuminating module 13 to pivot relative to the surveillance camera 12.

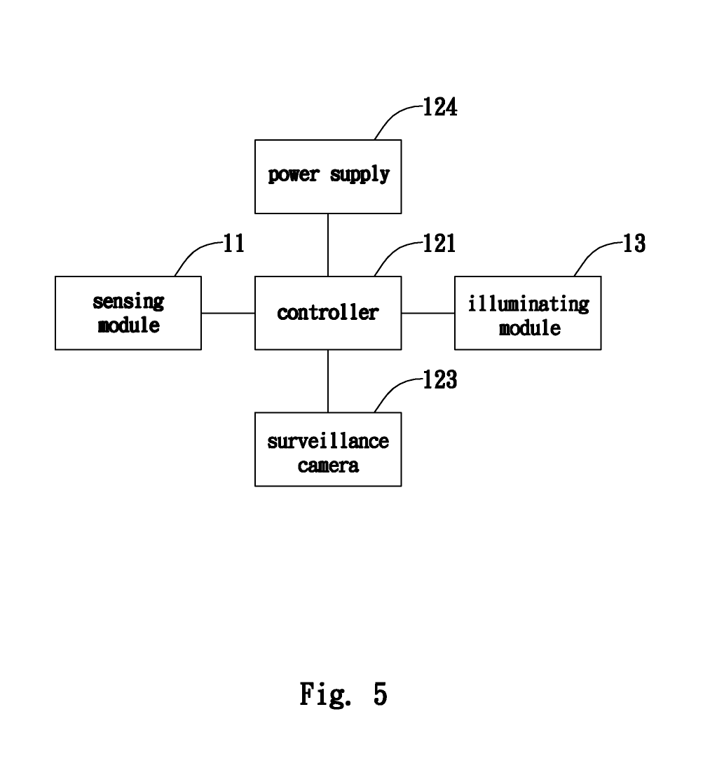

From the disclosure of FIG. 5, it is noted that the power supply 124 is electrically connected to the controller 121 as well as the surveillance camera 123 such that after the sensing module 11 senses a human body temperature and the environment luminance, which are greater than predetermined values stored in the controller 121, the controller 121 sends out the controlling signal to the illuminating module 13 to illuminate the background.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An illuminating surveillance camera comprising:
a sensing module to sense a human body temperature and environment luminance and generate a characteristic signal;
a surveillance camera module having a controller to generate a controlling signal in response to the characteristic signal; and
an illuminating module installed on a side of the surveillance camera to project light in response to the controlling signal.

2. The illuminating surveillance camera as claimed in claim 1, wherein the surveillance camera module has a housing, a surveillance camera embedded inside the housing for capturing an image to be processed by the controller and a power supply electrically connected to the controller to supply electricity to the surveillance camera as well as the illuminating module.

3. The illuminating surveillance camera as claimed in claim 1, wherein illuminating module has an illuminating unit.

4. The illuminating surveillance camera as claimed in claim 3, wherein the illuminating module is a decorative LED lighting module, a laser lighting module or a fluorescent lighting module.

5. The illuminating surveillance camera as claimed in claim 4, wherein the illuminating unit is a light emitting diode or a light bulb.

6. The illuminating surveillance camera as claimed in claim 5, wherein color of light projected by the illuminating module is red, orange, yellow, green, blue, indigo or violet.

7. The illuminating surveillance camera as claimed in claim 6, wherein the projected light by the illuminating module presents a drawing, a character, or a combination thereof.

8. The illuminating surveillance camera as claimed in claim 1 further comprising a connector connected between the surveillance camera and the illuminating module.

9. The illuminating surveillance camera as claimed in claim 2 further comprising a connector connected between the surveillance camera module and the illuminating module.

10. The illuminating surveillance camera as claimed in claim 3 further comprising a connector connected between the surveillance camera module and the illuminating module.

11. The illuminating surveillance camera as claimed in claim 4 further comprising a connector connected between the surveillance camera module and the illuminating module.

12. The illuminating surveillance camera as claimed in claim 5 further comprising a connector connected between the surveillance camera module and the illuminating module.

13. The illuminating surveillance camera as claimed in claim 6 further comprising a connector connected between the surveillance camera module and the illuminating module.

14. The illuminating surveillance camera as claimed in claim 7 further comprising a connector connected between the surveillance camera module and the illuminating module.

15. The illuminating surveillance camera as claimed in claim 8, wherein the connector is connected to the illuminating module to allow the illuminating module to pivot relative to the surveillance camera module.

16. The illuminating surveillance camera as claimed in claim 9, wherein the connector is connected to the illuminating module to allow the illuminating module to pivot relative to the surveillance camera module.

17. The illuminating surveillance camera as claimed in claim 10, wherein the connector is connected to the illuminating module to allow the illuminating module to pivot relative to the surveillance camera module.

18. The illuminating surveillance camera as claimed in claim 11, wherein the connector is connected to the illuminating module to allow the illuminating module to pivot relative to the surveillance camera module.

19. The illuminating surveillance camera as claimed in claim 12, wherein the connector is connected to the illuminating module to allow the illuminating module to pivot relative to the surveillance camera module.

20. The illuminating surveillance camera as claimed in claim 13, wherein the connector is connected to the illuminating module to allow the illuminating module to pivot relative to the surveillance camera module.
